(19) United States
(12) Patent Application Publication
(10) Pub. No.: US 2015/0007129 A1
(43) Pub. Date: Jan. 1, 2015

(54) SCRIPT EXECUTION FRAMEWORK

(71) Applicant: JOHN ALEX WILLIAM, Trichy (IN)

(72) Inventor: JOHN ALEX WILLIAM, Trichy (IN)

(21) Appl. No.: 13/930,416

(22) Filed: Jun. 28, 2013

(51) Int. Cl. G06F 9/44

(52) U.S. Cl. CPC G06F 8/30
USPC 717/106

(57) ABSTRACT

A business intelligence (BI) script framework is generated to simulate a business process and generate an associated BI report including analytical data of the business process. To generate the BI script framework, a selection of a script-pattern residing in a data source is received. Source tags corresponding to the selected script-pattern are determined, to be able to receive an input. From an associated user interface, BI script is received as an input to the source tags, to execute the business process. The BI script received from the UI is embedded with the selected script-pattern to generate a BI source code. The generated BI source code is validated and processed to generate the BI script framework. The BI script framework is operable to simulate the business process and generate a corresponding BI report, which can be used for decision-making.

### BACKGROUND

Business Intelligence (BI) includes a category of software systems and applications that are used to improve business enterprise decision-making and governance. These software tools provide techniques for analyzing and leveraging enterprise applications and data. These tools are commonly applied to financial, human resource, marketing, sales, service provision, customer, and supplier analyses. BI tools work with data management systems to collect, store, and manage raw data and transactional data generated by enterprise systems.

Business Intelligence tools available today can generate reports from diverse data sources that aid in decision-making. While handling complex algorithm associated with multi-threaded programs, viewing a potential resultant of a business process ahead of execution helps in decision making. This requires simulation of the business process with actual data.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram illustrating a system to generate a business intelligence script execution framework, according to an embodiment.

FIG. 2 is a block diagram illustrating a system to generate a business intelligence script execution framework, according to an embodiment.

FIG. 3 is a flow diagram illustrating process to generate a business intelligence script execution framework, according to an embodiment.

FIG. 4 is a table illustrating a data structure to generate a business intelligence script execution framework, according to an embodiment.

FIG. 5 is a user interface illustrating an instance of a data structure to generate a business intelligence script execution framework, according to an embodiment.

FIG. 6 is a user interface illustrating an analytical data structure generated by a business intelligence script execution framework, according to an embodiment.

FIG. 7 is a block diagram illustrating an exemplary computer system, according to an embodiment.

### DETAILED DESCRIPTION

Embodiments of techniques to generate a business intelligence (BI) script execution framework are described herein. A BI script execution framework allows a user of the framework to write a script containing business logic to execute a corresponding business process. Such a script is processed using the BI script framework such that multithreaded processes associated with the business process are simulated and a semantically operational report is generated. The report containing potential resultant of the execution of the business process may be used to make business decisions. For instance, if a sales report of the month January 2013 can be simulated ahead of time, say on 15^{th} day of January 2013, instead of waiting till the 1^{st} day of (the subsequent month) February 2013, business decisions can be taken to rectify or improve actual resultant based on the simulated resultant. For instance, business decisions like: increasing production to maintain planned revenue, can be taken ahead of time instead of waiting till the actual execution of the business process.

In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

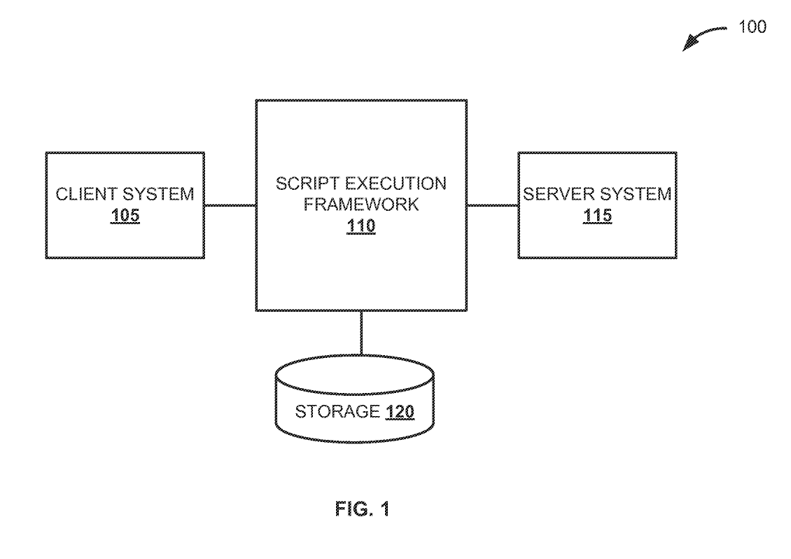

FIG. 1 is a block diagram illustrating system 100 to generate a script execution framework, according to an embodiment. A script execution framework may be operable to receive a script written by a user or generated by a module associated with a client machine and to execute the script along with a corresponding source code on a server machine. System 100 illustrates one such system, where client system 105 receives a written business intelligence (BI) script (either elementary or elaborate) to execute a corresponding business process, and sends the written BI script to script execution framework 110. Script execution framework 110 compiles an executable source code based on the BI script, and is executed on server system 115.

In an embodiment, a business process may be simulated ahead of an actual execution using script execution framework 110. A business process represents any group of activities that are required to be executed to achieve an end result. For instance, execution of “sales report for year 2013” can depict a business process to achieve an end result “revenue generated for year 2013”. Business logics, representing instructions to handle information exchange and processing between two entities, may be involved in executing the business processes. Such business logics include business rules and workflows representing business policies and orchestrations of tasks, respectively. The business policies and/or the orchestrations of tasks may depend on various attribute based on an end-user requirement and an intended result. In such cases, a configuration module (e.g. a system) or an administrator (e.g. a user) of a system, associated with system 100 may need to have an awareness and understanding about source codes associated with the execution of the business process. In addition, the configuration module or the administrator should be aware of various business data service providers (e.g. domain specific languages, business warehouse, reporting and analytical tools) and their respective functionalities available to carry out such business processes.

A BI script framework such as script execution framework 110 acts as a BI functionality that allows scripts to be generated by the configuration module and/or written by the user, which are compiled with the existing instructions to execute the business process. The instructions along with metadata related to the business process may be stored in storage 120. These scripts (also referred to as “Bi scripts) may be as elaborate as writing an entire source program for execution, or as minimal as changing one or more values of policies or instructions associated with the business logic. An elaborate script writer (user or module) may write the entire source codes corresponding to the business data service providers and the functionalities associated with the business process. A minimal script writer (a user or a script generation module) may write mere variables in the available source codes as inputs to script execution framework 110.

Providing such a BI script framework (e.g. 110) enables a client system 105 (e.g. a user or a system) to execute the business process at server system 115, even with nominal input from client system 105. BI script framework 110 provides a feature of simulating the business process at server system 115, with the input received from client system 105. Simulating the business process may be advantageous to be able to view a potential resultant of the business process in correspondence with the input received, ahead of an actual execution. In this way, the actual execution of the business process and any operations related to the execution are imitated by BI script framework 110, in advance of the actual execution. Based on the simulated results, business decisions, such as of betterment or advancement or modification of the actual execution of the business process, can be constructed.

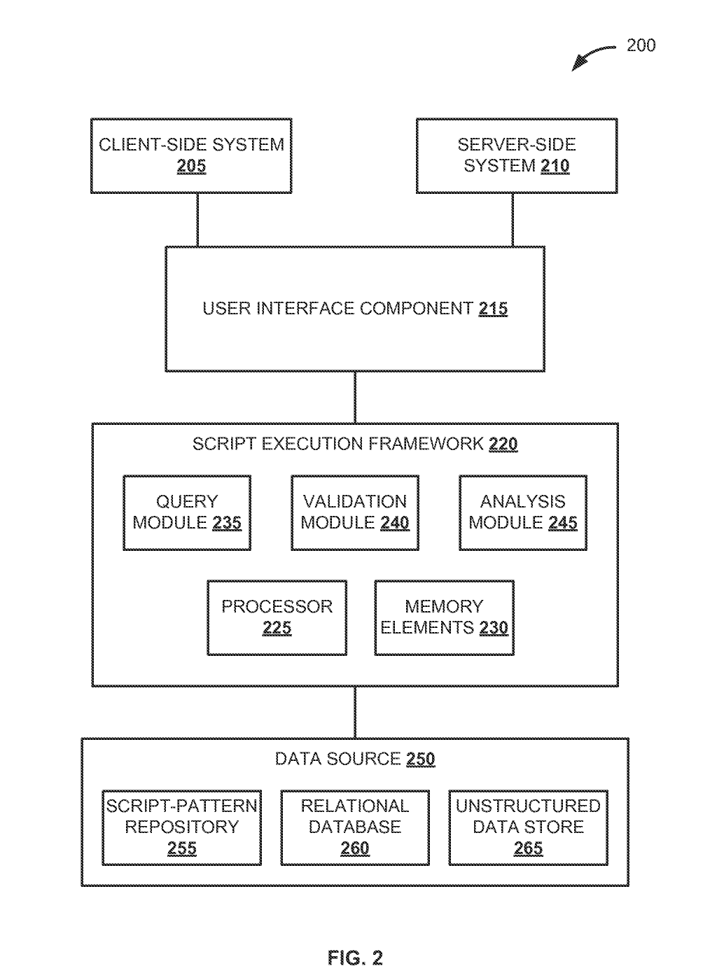

FIG. 2 is a block diagram illustrating system 200 to generate a script execution framework, according to an embodiment. System 200 includes client-side system 205, server-side system 210, and user interface component 215 that allows interactions between client-side system 205 and server-side system 210 with script execution framework 220. Script execution framework 220 includes query module 235, validation module 240, analysis module 245, processor 225 and memory elements 230. Memory elements 230 store instructions to generate modules 235-245 of script execution framework 220 when executed by processor 225.

In an embodiment, from a user interface (UI) associated with user interface component 215, client-side system 205 sends a selection of a business process to simulate an execution of the selected business process. In an embodiment, server-side system 210 renders a list of business processes, and client-side system 205 selects at least one business process for execution. A selection of a data service provider may also be received via the UI associated with UI component 215. This selection may be initiated by client-side system 205 or server-side system 210. For client-side system 205 to select the data service provider, server-side system 210 may render a list of data service providers available to execute the selected business process. Upon receiving the selection of the business process and the selection of the data service provider to process the business process, server-side system 210 generates a list of script-patterns available for the selected data service provider. Upon selecting a script-pattern via UI component 215, script execution framework 220 is triggered for simulation. In an embodiment, script-pattern represents parameters associated with the execution of a corresponding business process. Script-patterns represent the parameters that include executable instructions or machine codes, or instructions available with server-side system 210 to execute a corresponding business process. In an embodiment, source tags represent parameters that receive input from a user or a machine, to execute a corresponding business process. In an embodiment, unstructured data store 265 stores the parameters and associated data for retrieval. In an embodiment, information related to the data service provider is stored in data store 250.

Upon receiving the trigger to simulate the execution from UI component 215, query module 235 associated with script execution framework 220 generates a query by determining a plurality of result objects and a plurality of query filters. Result objects and query filters represent a plurality of source tags operable to receive an input. Based upon the input to the source tags associated with the script-pattern, an analytical report is generated as a resultant of the execution of the business process. Result objects may include a plurality of fields that are represented as report fields the analytical report, and the query filters may include a plurality of conditions to be satisfied to generate the analytical report. For instance, consider a business process, “a university admission process”. Result objects include ‘name of student’, ‘aggregate score of eight subjects’ and ‘aggregate science score of three subjects’; and query filters include ‘total score greater than or equal to 700’, ‘science score greater than or equal to 260’, and ‘literature score greater than or equal to 150’. The query including the result objects and the query filters is generated by query module 235.

For the query, one or more business rules are obtained to generate the analytical business report associated with the business process. In an embodiment, BI script is received from client-side system 205 in the form of the business rules. The business rules include conditions to execute the business process. Exemplary business rules for the university admission process are illustrated in the following table, Table 1.

TABLE 1

| | |
|---|---|
| BUSINESS RULE 1 | IF (Science score ≧260) = APPROVE |
| | TECHNICAL EDUCATION ADMISSION |
| BUSINESS RULE 2 | IF (Science score <260) = DISAPPROVE |
| | TECHNICAL EDUCATION ADMISSION |
| BUSINESS RULE 3 | IF (Literature score ≧150) = APPROVE |
| | LITERATURE EDUCATION ADMISSION |
| BUSINESS RULE 4 | IF (Science score of student 1 >260) + IF |
| | (Literature score of student 1 >150) + IF |
| | (student 1 accepts technical education admission) = |
| | REMOVE student 1 from literature education |
| | admission list |
| BUSINESS RULE 5 | IF (Aggregate score <500) = DISQUALIFY |
| | APPLICATION |

In an embodiment, query module 235 determines one or more source tags associated with the select script-pattern. Source tags are operable to receive BI script as input to execute the business process. The input received for the source tags include the result objects, the query filters, and the business rules to execute the business process. In an embodiment, the source tags are operable to receive elementary inputs, including mere variables or values for variables present in an available BI script, associated with the selected script-pattern. In another embodiment, the source tags are operable to receive an entire source code, business data, variables, values, functionalities and the like. In an embodiment, BI script is received from client-side system 205 in the form of input to the source tags.

Validation module 240 embeds the received BI script along with the selected script-pattern to generate a BI source code. Embedding the BI script along with the script-pattern includes receiving the input to the source tags (as variables, values, etc.) present in the script-pattern. For instance, if the BI script included one or more values to corresponding source tags associated with the selected script-pattern, the values received in the form of the BI script is embedded in the script-pattern to generate an executable BI source code. In another instance, if the BI script included an entire source code as input to corresponding source tags associated with the selected script-pattern, the source code is implanted in the script-pattern, along with other parameters associated with the selected business process to generate the executable BI source code.

Upon embedding the received BI script along with the selected script-pattern (e.g. parameters), the BI source code that is generated is validated by validation module 240. Validating the BI source code includes a determination that the BI source code meets necessary specifications to execute the business process. These specifications may represent a protocol to represent the BI source code to script execution framework 220, for execution/simulation. Upon validating the 131 source code, script execution framework 220 simulates an execution of the business process, and generates a data visualization depicting the simulation. In an embodiment, based on the BI Script, an instance of the script execution framework is generated to simulate the execution of the business process.

In an embodiment, server-side system 210 is operable to receive a trigger to simulate the execution of the business process. In response to the trigger, server-side system 210 simulates the execution by operating script execution framework 220. Operating the script execution framework 220 includes receiving the selection of a script-pattern from the plurality of script-patterns residing in script-pattern repository 255; embedding the BI script received and the script-pattern selected to generate the BI source code and to simulate the execution to generate the data visualization. This data visualization may be an exemplary BI report including potential resultant of the execution of the business process, to make business decisions. In an embodiment, script execution framework 220 receives the BI source code and generates a plurality of BI classes. Based upon the BI classes, the BI source code is executed in script execution framework 220 to generate the BI report for the business process. In an embodiment, generating the plurality of BI classes includes generating an actual class and a nested class of each BI class. The actual class and the nested class are operable to receive user content. Publication conditions may be associated with the user content, to restrict access and/or publication of the content to all the users. For example, consider a business process “SALES REPORT FOR YEAR 2013” involving two sales persons X and Y. A sales manager who accesses this business report may not want X to see Y's performance, and vice versa. In this situation, publication conditions may be created for rendering certain business content as a resultant of execution of the business process. Such publication conditions associated with the received user content is determined and stored along with the user content in an associated temporary bin. While an execution is performed, processor 225 may parse the temporary bin to determine any associated publication content. Similarly, the actual class and the nested classes are stored along with the selected BI pattern in the temporary bin. In an embodiment, client-side system 205 is operable to receive the request to execute the business process. Upon receiving the selected business process, client-side system 205 generates a plurality of script-patterns, and receives a selection of one of the script-pattern. Client-side system 205 provides the BI script as the input to the source tags associated with the selected script-pattern, and triggers the simulation to execute the business process. In an embodiment, generating the script-patterns configuring the script-patterns based upon a selected data service provider. The script-patterns include reusable instructions, solutions and content to commonly occurring codes in a program. A script-pattern may be a complete or an incomplete reusable solution that can be transformed to source code by appending corresponding inputs from client-side system 205. Such script-patterns are configurable depending on the selected data service provider and the business process to be executed. By doing so, a set of script-patterns are available for multiple executions of the business process associated with the data service provider, at various instances. To configure such script-patterns, pattern keys and display values are generated for the selected data service provider. Pattern keys and display values represent various functionalities and classifications of script-pattern. Utility methods and associated member variables are generated for the selected business process. Utility methods represent structures, collaborations, implementations, and various other contexts in which the script-pattern can be utilized. Input member variables provided for such methods are applied according to documentation formats of the script-pattern. Based upon the input received for the pattern keys and the display values, the script-patterns may be configured for the corresponding business process.

In an embodiment, script execution framework 220 is in communication with server-side system 210 and client-side system 205 to simulate the execution of the business process. Script execution framework 220 is also operable to receive a script written by a client machine and execute the script along with a corresponding source code on a server machine. Various business logics may be involved in executing complex business processes having multiple threads. The multiple threads of business process may illustrate sequence of programmed instructions that are executed independently and/or interdependently to achieve an end result. For instance, determining relationships between ten family members may represent a multithreaded business process. The multithreaded illustration can be described by the number of relationships each member shares between each other. Script execution framework 220 is operable to execute multithread processes.

Analysis module 245 associated with script generation framework 220 is operable to receive a plurality of filters and a plurality of result objects as query elements. Analysis module 245 queries relational database 260, to retrieve parameters corresponding to the business process (multithreaded process). Analysis module 245 is operable to provide the business process in script execution framework 220, based on the query elements.

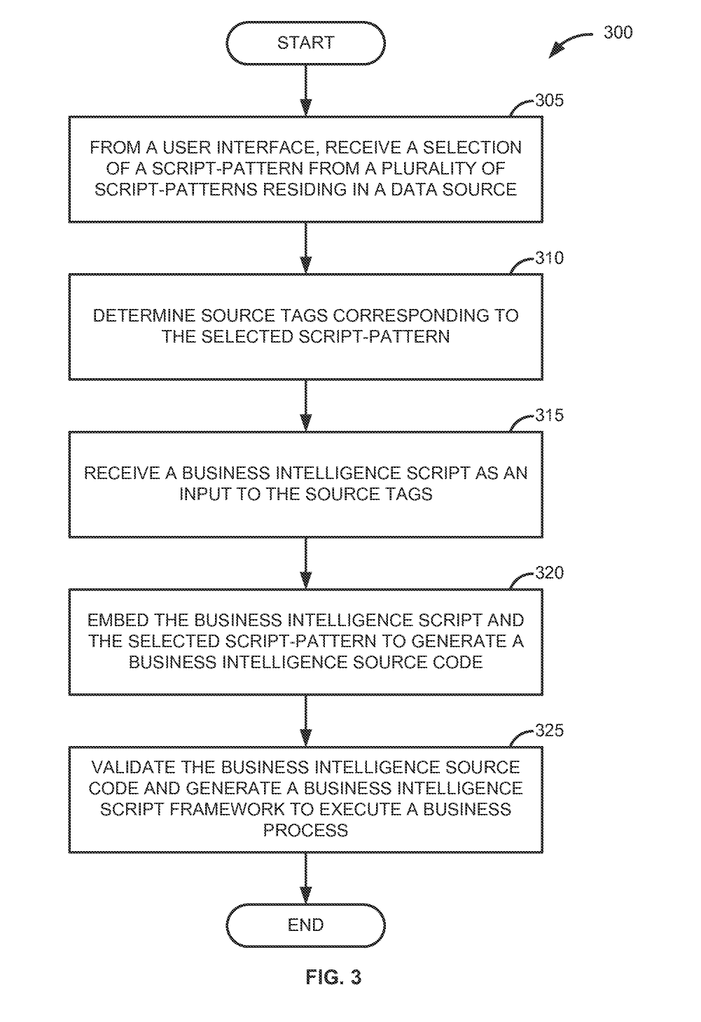

FIG. 3 is a flow diagram illustrating process 300 to generate a script execution framework, according to an embodiment. A script execution framework, also referred to as a “business intelligence (BI) script execution framework” may be generated to simulate a business process and generate an associated BI report that includes analytical data of the business process. At certain instances, the business process may require corresponding inputs to execute the business process according to the instances. In such cases, instead of having to configure an entire algorithm or a source code associated with the execution of the business process, elementary or elaborate scripts may be received from an entity that triggers the execution of the business process. The business process may now be executed based on the received scripts. The business process may be executed on a number of available data service providers, with each provider being associated with corresponding script-patterns.

Upon selecting one such service provider, an associated processor retrieves a plurality of script-patterns corresponding to the selected service provider. In an embodiment, at 305, a selection of a script-pattern from the plurality of script-patterns residing in a data source (associated with the exemplary selected data service provider) is received. The selected script-pattern is analyzed to determine a plurality of source tags associated with the script-pattern, which are operable to receive an input, at 310.

At 315, a business intelligence (BI) script is received as an input to the source tags corresponding to the selected script-pattern, to execute the business process. The received BI script and the selected scrip-pattern are embedded to generate a BI source code, at 320. In an embodiment, the source code includes a complete program that is operable to execute the business process according to a plurality of business logics specified in the BI script. The BI source code is validated and a BI script framework is generated at 325, to execute a business process.

In an embodiment, the BI script is configured to receive the BI source code and generate a plurality of BI classes, each representing an instance of the business process according to the BI script. The BI source code is executed based upon the BI classes, to generate a BI report of the business process. The BI report may include simulated analytical data of the business process.

In another embodiment, the BI script framework is configured to simulate the business process according to a planned business rule, and generate a semantic analysis for the execution of the business process according to an actual business rule. For instance, consider a “seat-selection process for Wimbledon tennis tournament” to be the business process that needs to be executed. Simulating the business process ahead of the actual execution may be beneficial to determine the number of selections for every match, every set and every game. Consider a spectator ‘A’ who wants to watch the first and the second set of a particular match; spectator ‘B’ wants to watch the second and the third set; spectator ‘C’ wants to watch the entire match; and spectator ‘D’ wants to watch all the matches played on a particular day. If spectator ‘D’ were to choose a particular seat number ‘Z12’ for the entire day, the seat ‘Z12’ needs to be removed during the seat selection for the rest of the spectators. Also, if spectator ‘D’ were to choose the seat after spectator ‘A’ choose his seat, the availability of seat number ‘Z12’ may be provided to spectator ‘D’ for the rest of the game and rest of the day. Such planned business rule may be submitted as the BI script for a selected pattern associated with the execution of the “seat-selection process for Wimbledon tennis tournament”. By simulating such a business process, the analytical data of the actual resultant—which may include an actual availability of seats for selection at actual instances, may be determined. If any modifications or adjustments need to be made to the seats available, or the number of highest-opted seats, or a row of seats under maintenance, and the like, an event-manager responsible for booking the seats may be informed ahead of time. The instances of an actual seat-selection carried out by each spectator may represent the actual business rule.

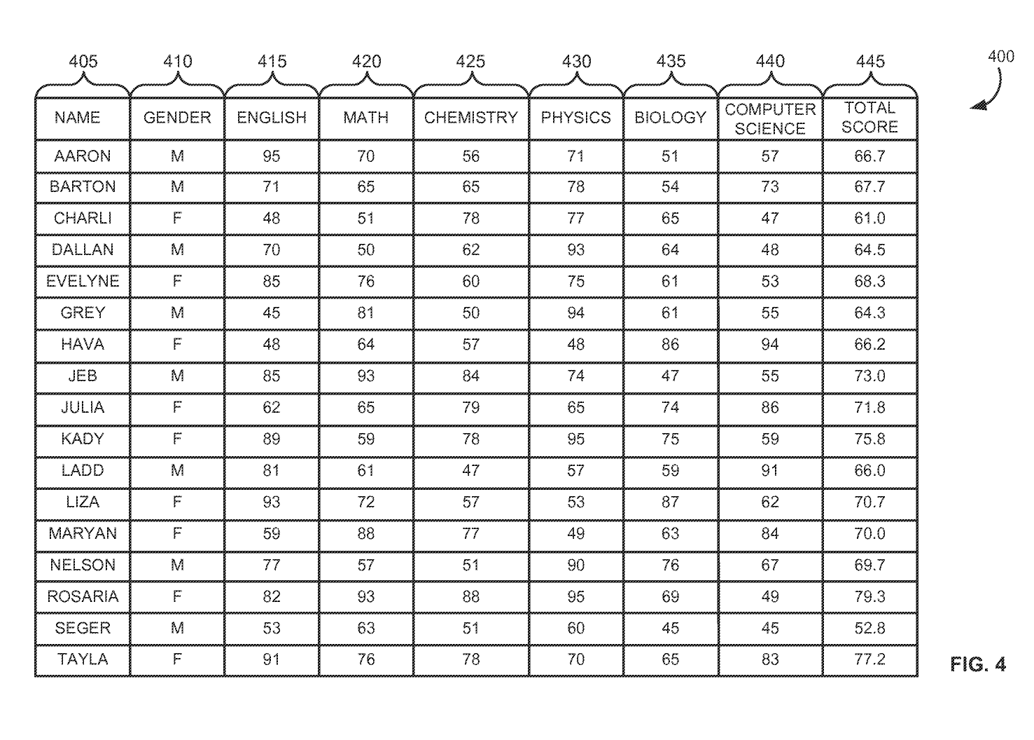

FIG. 4 is a table illustrating a data structure 400 to generate a business intelligence script execution framework, according to an embodiment. A script execution framework is generated to simulate a business process and generate an associated BI report including analytical data of the business process. FIG. 4 illustrates a table data structure 400, representing a set of data elements and their associated values, organized using a model of columns and rows for a business process “UNIVERSITY SEAT SELECTION”. Each column represents a unique field of an elementary-report, including NAME 405, GENDER 410, and scores in each subject—ENGLISH 415, MATH 420, CHEMISTRY 425, PHYSICS 430, BIOLOGY 435, COMPUTER SCIENCE 440 and TOTAL SCORE 445. The values in each row represent a score in a corresponding subject acquired by each student. The last column TOTAL SCORE 445 represents an average of the total score of all subjects.

To generate the script execution framework, a selection of a script-pattern residing in a data source—is received. Source tags corresponding to the selected script-pattern are determined, to be able to receive an input. From an associated user interface, business intelligence (BI) script is received as an input to the source tags, to execute the business process. The BI script received from the UI is embedded with the selected script-pattern to generate a BI source code. The generated BI source code is validated and processed to generate the script execution framework. Such a generated BI script execution framework is operable to simulate the business process and generate a corresponding BI report, which can be used for decision-making.

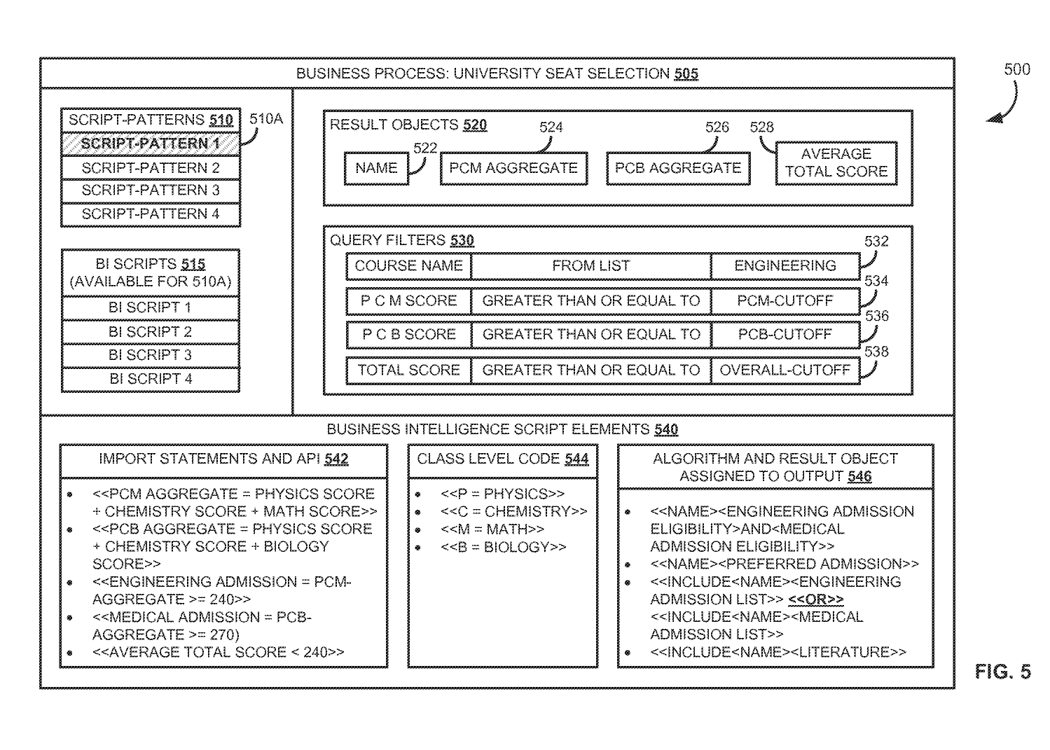

FIG. 5 illustrates user interface 500 illustrating an instance of a data structure to generate a business intelligence script execution framework, according to an embodiment. User interface 500 includes user interface elements representing a visualization of the generation and usage of the script execution framework (BI script framework). A UNIVERSITY SEAT SELECTION 505 represents a selected business process, to be executed on the (BI script) framework. A plurality of available script-patterns 510 (e.g. SCRIPT-PATTERN 1, SCRIPT-PATTERN 2, SCRIPT-PATTERN 3, and SCRIPT-PATTERN 4) associated with the selected business process 505 are retrieved and rendered on UI 500. A selection of at least one script-pattern, SCRIPT-PATTERN 1 510A is received on SCRIPT-PATTERNS 510. In an embodiment, available 131 scripts 515 for selected SCRIPT-PATTERN 1 510A are received and rendered on UI 500. A user is provided with an option of selecting available BI scripts 515 (e.g. BI SCRIPT 1, BI SCRIPT 2, BI SCRIPT 3, BI SCRIPT 4). If a user wants to write a BI script, he/she may do so by providing result objects 520, query filters 530 and the BI script (alternatively referred to as BI script elements 540) as input to associated source tags (e.g. UI elements 542, 544 and 546). Based upon selected SCRIPT-PATTERN 1 510A, associated source tags are determined and rendered on UI 500. In an embodiment, result objects 520 and query filters 530 along with other UI elements 542, 544 and 546 constitute the source tags, which are operable to receive input.

Accordingly, result objects 520 including NAME 522, PCM (physics, chemistry, and math) AGGREGATE 524, PCB (physics, chemistry, and biology) AGGREGATE 526 and AVERAGE TOTAL SCORE 528 are selected as report fields to be visualized in the analytical report (to be generated, at this instance).

Query filters 530 representing business rules: ‘COURSE NAME: SELECT FROM LIST: ENGINEERING’ 532; ‘PCM (Physics Chemistry Math) SCORE: GREATER THAN OR EQUAL TO: PCM_CUTOFF’ 534; ‘PCB SCORE: GREATER THAN OR EQUAL TO: PCB_CUTOFF’ 536; AND ‘TOTAL SCORE: GREATER THAN OR EQUAL TO: OVERALL_CUTOFF’ 538 are provided as filters to process data in the data structure.

Based upon selected SCRIPT-PATTERN 1 510A, other source tags including ‘IMPORT STATEMENTS AND APT’ 542, ‘CLASS LEVEL CODE’ 544, and ‘ALGORITHM AND RESULT OBJECT ASSIGNED TO OUTPUT’ 546 are provided to receive a BI script. For instance, consider a cutoff score for engineering admission is 240 out of 300 marks scored in physics, chemistry and math; and that for medical admission is 270 out of 300 marks scored in physics, chemistry and biology. The BI script (e.g. 520, 530, 540) thus written is embedded along with selected SCRIPT-PATTERN 1 510A, to generate a BI source code, SCRIPT-PATTERN 1 510A includes rest of the program associated with the execution of UNIVERSITY SEAT SELECTION 505. For instance, SCRIPT-PATTERN 1 510A includes reusable instructions and/or code for every business process that does not contain source tags configured to receive input.

In another example, SCRIPT-PATTERN 1 510A is completely available for modification, and based upon an expected resultant, an entire BI source code is written and provided as an input. In certain examples, SCRIPT-PATTERN 1 510A includes an entire BI source code, and is operable to receive various values for parameters in the BI source code. Here, only such parameters operable to receive values as input are rendered on UI 500. Thus, BI script elements may include any one or more of result objects 520, query filters 530, BI script elements 540, import statements and predefined application program interfaces (APIs) 542, class level code 544 and algorithm and result object assigned to output 546.

Upon embedding the BI script along with SCRIPT-PATTERN 1 510A, a BI source code is generated. The BI source code is validated to determine whether the BI source code meets necessary specifications to execute the business process. If a result of the validation is negative, any errors occurring in the generated BI source code may be fixed. Upon validation, a trigger to simulate the execution of business process UNIVERSITY SEAT SELECTION 505 is received. Simulating UNIVERSITY SEAT SELECTION 505 includes parsing every element (row) from the data structure illustrated in FIG. 4, to determine an output as a result of the business process. Here, the algorithm and result object assigned to output is executed according to the BI source code. This includes executing the entry NAMES 405 in data structure 400 according to the BI source code to check if AARON (first entry in column 405) is eligible for medical admission and for engineering admission, if AARON is eligible for both, a determination of preferred course is made, and AARON is assigned to the preferred course admission list.

If AARON is eligible for engineering admission only, AARON is assigned to the engineering admission list, if AARON was eligible to both, and prefers engineering, AARON's name is entered in engineering admission list only. If AARON was eligible to both, and prefers medical, AARON's name is entered in medical admission list only. If AARON is neither eligible to medical nor to engineering, AARON's name is entered in literature admission list. Thus, by simulating the multithreaded admission process of medical admission, engineering admission and literature admission, an actual UNIVERSITY SEAT SELECTION admission list can be prepared beforehand, HAVA (ROW 7) is eligible for engineering admission, but her preference is medical admission. Here, the eligibility overrides the preference, and the admission column for ROW 7 is updated as engineering. LADD (ROW 11) prefers medical admission, and his eligibility is medical or engineering. Hence, the admission column of ROW 11 is updated as medical, SEGER (ROW 16) is eligible for literature alone. Hence, though his preference is medical or engineering, the admission column of ROW 16 is updated as literature.

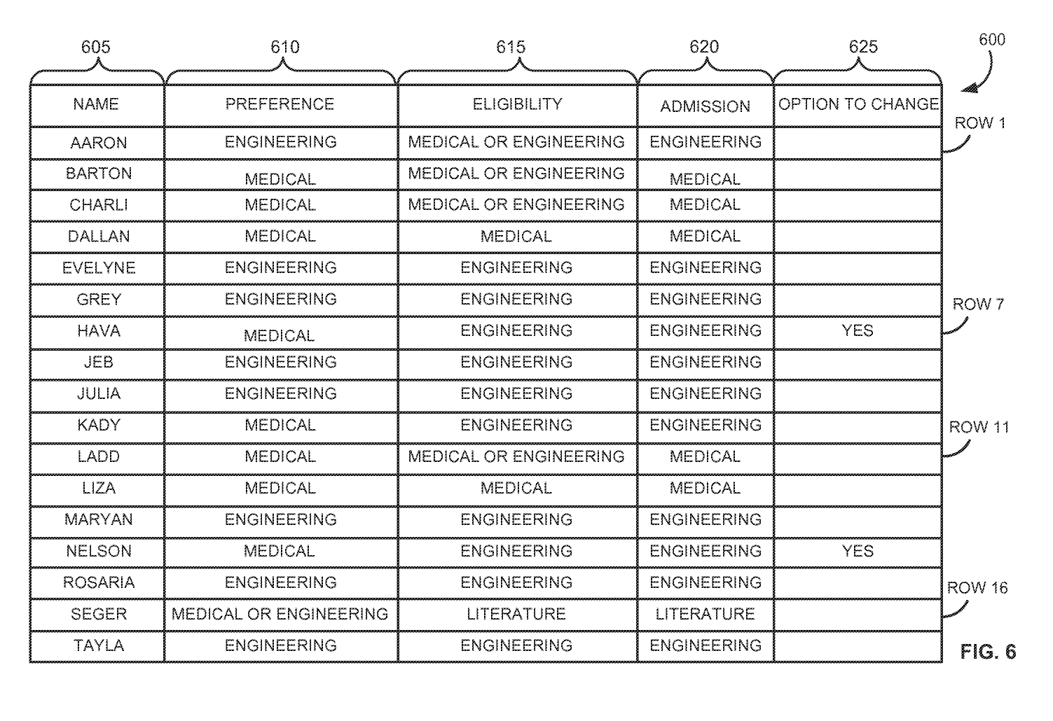

FIG. 6 illustrates analytical data structure 600 generated by a business intelligence script execution framework, according to an embodiment. A BI script framework is generated by receiving BI script written by a user or generated by a machine, as an input. The BI script is sent to a server system from a client system. The BI script written at the client system is executed in the server system to generate a semantically operational report. The data structure 400 illustrated in FIG. 4 is simulated in the BI script execution framework as explained in FIG. 5, to generate a semantically operational report with data structure 600.

The business process UNIVERSITY SEAT SELECTION 505 (FIG. 5) is a multithreaded business process, including multiple threads associated with engineering admission list, medical admission list and literature admission list. By simulating such a business process, analytical data of the actual resultant is determined. By generating such analytical data, in a form of semantically operational report, adjustments and/or modifications may be made to the seats availability. For instance, if ten medical seats are remaining after generating the medical admission list, the ten seats may be provided to ten students who preferred medical admission, but were not eligible due to the eligibility criteria. These ten students are determined by a ranking of students based on their scores, preference, and eligibility. Thus, during the actual execution of UNIVERSITY SEAT SELECTION 505, these ten students may be provided with a choice of admission to medical and engineering. The analytical data structure including semantically operational report 600 includes the NAME 605, PREFERENCE 610, ELIGIBILITY 615, ADMISSION 620 and OPTION TO CHANGE 625, if any, as a result of the simulation. Based on such semantically operational report 600, business decisions can be established.

Sonic embodiments may include the above-described methods being written as one of more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

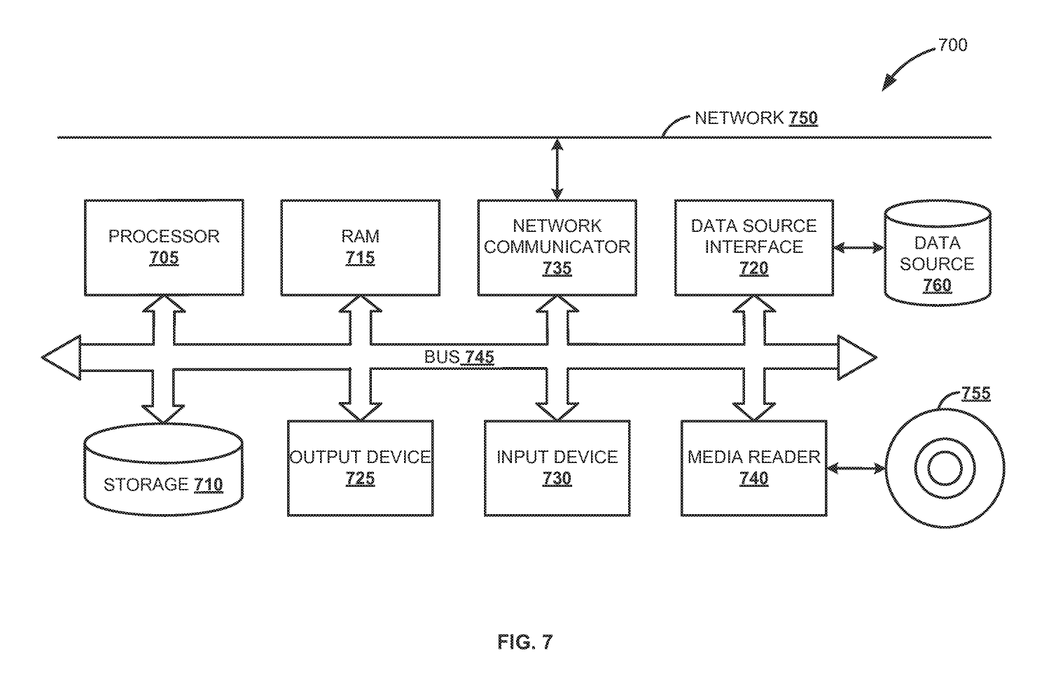

FIG. 7 is a block diagram of an exemplary computer system 700. The computer system 700 includes a processor 705 that executes software instructions or code stored on a computer readable storage medium 755 to perform the above-illustrated methods. The processor 705 can include a plurality of cores. The computer system 700 includes a media reader 740 to read the instructions from the computer readable storage medium 755 and store the instructions in storage 710 or in random access memory (RAM) 715. The storage 710 provides a large space for keeping static data where at least some instructions could be stored for later execution. According to some embodiments, such as some in-memory computing system embodiments, the RAM 715 can have sufficient storage capacity to store much of the data required for processing in the RAM 715 instead of in the storage 710. In some embodiments, all of the data required for processing may be stored in the RAM 715. The stored instructions may be further compiled to generate other representations of the instructions and dynamically stored in the RAM 715. The processor 705 reads instructions from the RAM 715 and performs actions as instructed. According to one embodiment, the computer system 700 further includes an output device 725 (e.g., a display) to provide at least some of the results of the execution as output including, but not limited to, visual information to users and an input device 730 to provide a user or another device with means for entering data and/or otherwise interact with the computer system 700. Each of these output devices 725 and input devices 730 could be joined by one or more additional peripherals to further expand the capabilities of the computer system 700. A network communicator 735 may be provided to connect the computer system 700 to a network 750 and in turn to other devices connected to the network 750 including other clients, servers, data stores, and interfaces, for instance. The modules of the computer system 700 are interconnected via a bus 745. Computer system 700 includes a data source interface 720 to access data source 760. The data source 760 can be accessed via one or more abstraction layers implemented in hardware or software. For example, the data source 760 may be accessed by network 750. In some embodiments the data source 760 may be accessed via an abstraction layer, such as, a semantic layer.

A data source is an information resource. Data Sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Data Base Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in detail.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments one or more embodiments to the precise forms disclosed. While specific embodiments of and examples for, the one or more embodiments are described herein for illustrative purposes, various equivalent modifications are possible within the scope, as those skilled in the relevant art will recognize. These modifications can be made in light of the above detailed description. Rather, the scope is to be determined by the following claims, which are to be interpreted in accordance with established doctrines of claim construction.

What is claimed is:

1. A computer implemented method to generate a script execution framework, comprising:
receiving, from a computer generated user interface, a selection of at least one script-pattern from a plurality of script-patterns residing in a data source associated with an execution of a business process;
determining one or more source tags operable to receive an input, the source tags corresponding to the selected script-pattern;
from the computer generated user interface, receiving a business intelligence (BI) script as the input to the one or more source tags, to execute the business process;
embedding the BI script and the selected script-pattern to generate a BI source code; and
based upon a validation of the BI source code, generating a BI script framework operable to execute the business process.

2. The computer implemented of claim 1, wherein the BI script framework is configured to:
receive the BI source code and generate one or more BI classes; and
based upon the one or more BI classes, execute the BI Source code to generate a BI report of the business process, the BI report including simulated analytical data of the business process.

3. The computer implemented of claim 1, wherein the BI script framework is configured to: simulate the business process according to a planned business rule, to generate operational semantics for the execution of the business process according to an actual business rule.

4. The computer implemented of claim 1, further including a method of generating the plurality of script-patterns, comprising:
upon receiving a selection of the business process, selecting a data service provider to process the BI script;
based on the selected data service provider, generating a query including one or more result objects and one or more query filters; and
describing one or more business rules to generate a business report associated with the business process.

5. The computer implemented method of claim 4, wherein generating the plurality of script-patterns comprising:
generating one or more pattern keys and one or more display values to receive a user input;
generating one or more utility methods and one or more member variables associated with the business process; and
based upon an input received for the pattern keys and the display values, configuring the plurality of script-patterns.

6. The computer implemented method of claim 4, wherein providing the script execution framework includes:
determining one or more result objects associated with a request for executing a business intelligence script;
based upon the result objects, generating an instance of the script execution framework to execute the business intelligence script associated with the result objects.

7. The computer implemented method of claim 2, wherein generating the BI classes includes:
generating an actual class and a nested class of each BI class, to receive user content;
determining one or more publication conditions associated with the user content; and
storing the actual class and the nested class in a BI class folder along with storing the selected pattern, the user content and the publication conditions in an associated temporary bin.

8. The computer implemented method of claim 1, wherein the script execution framework is capable of:
based on a trigger to execute the business process, receiving the BI script from a client system; and
executing the business process associated with the business intelligence script at a server side.

9. The computer implemented method of claim 1, wherein executing the business process includes: executing a simulation of a multithreaded process corresponding to the business process.

10. The computer implemented method of claim 9, wherein simulating the multithreaded process corresponding to the business process includes:
querying the data source associated with the execution of the business process, to determine a plurality of parameters corresponding to the multithreaded process;
receiving one or more filters and one or more result objects as corresponding one or more query elements;
embedding the received query elements and the plurality of parameters and executing the business process in the generated BI script framework; and
generating a data visualization depicting the simulation of the multithreaded process.

11. A computer system to generate a script execution framework, comprising:
a processor configured to read and execute instructions stored in one or more memory elements; and
the one or more memory elements storing instructions related to—
a script-pattern repository to store a plurality of script-patterns associated with an execution of a business process;
a query module to determine one or more source tags corresponding to a selected script-pattern from the plurality of script-patterns;
a user interface component to receive a business intelligence (BI) script as an input to the one or more source tags, to execute the business process;
a validation module to validate a BI source code that is generated by embedding the BI script and the selected script-pattern.

12. The computer system of claim 11 further comprising:
a server-side system operable to receive a trigger to simulate an execute the business process; and
the script execution framework operable to:
receive a selection of a script-pattern from the plurality of script-patterns residing in the script-pattern repository;
embed the BI script and the selected script-pattern to generate the BI source code; and
execute the business process and generate a data visualization depicting the simulation of the multithreaded process associated with the business process.

13. The computer system of claim 11 further comprising: a client-side system operable to:
request an execution of the business process;
select at least one script-pattern from the plurality of script-patterns;
provide the BI script as the input to the one or more source tags; and
trigger the simulation to execute the business process.

14. The computer system of claim 11, wherein: the script execution framework is in communication with the server-side system and the client-side system to simulate the multithreaded process associated with the business process.

15. The computer system of claim 11 further comprising: an analysis module operable to:
receive one or more filters and one or more result objects as corresponding one or more query elements;
query the data source associated with the execution of the business process, to retrieve a plurality of parameters corresponding to the multithreaded process; and
provide the business process in the generated BI script framework, based upon the query elements.

16. The computer system of claim 11, wherein the script execution framework is operable to:
receive the BI source code and generate one or more BI classes; and
based upon the one or more BI classes, execute the BI source code to generate a BI report of the business process, the BI report including stimulated analytical data of the business process.

17. The computer system of claim 11 further comprising: a relational database operable to store the parameters corresponding to the multithreaded process.

18. An article of manufacture including a non-transitory computer readable storage medium to tangibly store instructions, which when executed by a computer, cause the computer to:
receive from a computer generated user interface, a selection of at least one script-pattern from a plurality of script-patterns residing in a data source associated with an execution of a business process;
determine one or more source tags operable to receive an input, the source tags corresponding to the selected script-pattern;
from the computer generated user interface, receive a business intelligence (BI) script as the input to the source tags, to execute the business process;
embed the BI script and the selected script-pattern to generate a BI source code;
based upon a validation of the BI source code, generate a BI script framework operable to execute the business process; and
simulate a multithreaded process corresponding to the business process in the BI script framework.

19. The article of manufacture of claim 18 further including instructions to generate the plurality of script-patterns, comprising:
upon receiving a selection of the business process, selecting a data service provider to process the BI script;
based on the selected data service provider, generating a query including one or more result objects and one or more query filters; and
describing one or more business rules to generate a business report associated with the business process.

20. The article of manufacture of claim 18 including instructions for the BI script framework to:
receive the BI source code and generate one or more BI classes by
generating an actual class and a nested class of each BI class, to receive user content;
determining one or more publication conditions associated with the user content; and
storing the actual class and the nested class in a BI class folder along with storing the selected pattern, the user content and the publication conditions in an associated temporary bin; and
based upon the one or more BI classes, execute the BI source code to generate a BI report of the business process, the BI report including simulated analytical data of the business process.
